(19) United States
(12) Patent Application Publication
(10) Pub. No.: US 2007/0222625 A1
(43) Pub. Date: Sep. 27, 2007

(54) Emergency help locator switch

(76) Inventors: Richard Raymond Fisher, Moneta, VA (US); Richard B. Fisher, Bloomingdale, NJ (US)

Correspondence Address: EUGENE H. EICKHOLT, 1119 CAROLINE STREET, FREDERICKSBURG, VA, 22401, US

(21) Appl. No.: 11/376,043

(22) Filed: Mar. 15, 2006

(51) Int. Cl. G08B 13/00; G08B 5/00

(52) U.S. Cl. 340/574; 340/331

(57) ABSTRACT

This invention relates to electro-optical displays intended to alert emergency response personnel to the location of the emergency. A conventional electrical switch, as would normally be utilized for the on/off switching of electrical lighting or electrical outlets, is modified such that it activates a strong, luminescent signal when engaged in a signaling mode. By this signal, emergency personnel responding to a fire or medical emergency or criminal activity can readily and quickly identify the proper residence or place of business that is in need of assistance.

### BACKGROUND OF THE INVENTION

1. Field of the Invention

This invention is generally related to the field of emergency alert devices, and is specifically directed to a switch which will cause a light to flash to help direct emergency response personnel to the correct address.

2. Description of the Related Art

Devices to alert emergency personnel are well-known. Typical of such devices is enclosed in U.S. Pat. No. 6,367,179, to Marsh, the entire disclosure of which is hereby incorporated by reference. Marsh discloses an illuminated display sign apparatus intended to illuminate emergency exit signs. The invention of Marsh is a kit designed to retrofit existing emergency signs. It utilizes cold cathode fluorescent lamps to illuminate display surfaces, such as those in emergency exit signs, in a substantially uniform manner. It uses a small number of miniature tube-shaped lamps to illuminate the emergency signs, but it may be used in other applications as well.

Another prior art device is disclosed in U.S. Pat. No. 6,568,109 to Sanders, the entire disclosure of which is incorporated herein by reference. Sanders shows a changeable address display that can automatically adjust its light output intensity to ambient light conditions and is readily changeable to any address. The device can be remotely turned on by either a bright light or radio signal from an emergency vehicle. An LED 7-segment display with numerals and letters, 7-segment lamp tubes, a dot-matrix LED, electric light bulbs or tubes, or any other display means produces a display visible and readable to a person with normal vision at a distance of exceeding fifty (50) feet and preferably one hundred (100) feet during both the day and night. A photocell or other ambient-light sensing device automatically adjusts the intensity for various ambient conditions such as bright sunlight, night, fog, or other conditions. The device contains a circuit that allows immediate adjustment or change of the address. There are at least two embodiments of this feature: 1) the ability to set each digit with switches, and 2) counter circuit that causes the address to count when a button is depressed. The second embodiment can contain a slow/fast switch to control the counting speed.

Neither of the previously described prior art devices, unlike the instant invention, can be retrofit into a conventional gang electrical box, taking no more space than a conventional switch.

Another prior art device is disclosed in U.S. Pat. No. 5,070,327 to Ellingson, the entire disclosure of which is herein incorporated by reference. Ellingson teaches a signaling device whereby a three-position switch is used to control the operation of a light. The switch affects the normal on/off operation of the light by using a circuit interrupting device to make the light flash when the switch is in the second position. The switch also includes a small lamp or audible alarm to indicate to the user that the device is in the flash position.

### SUMMARY OF THE INVENTION

This invention is an “emergency help locator switch”. A single-pole, single-throw light switch with the on/off states is utilized, but the switch has been modified to include the additional state that would cycle a light in an on/off or flashing fashion. By observation of the flashing or strobing action of the activated light, emergency personnel can quickly identify the proper location for their response, thereby saving time and increasing the likelihood of a successful rescue. The switch can be located so that it will flash a light placed outside a residence or place of business on the porch, along the walkway, on a lamppost, at the end of the driveway or on hall lights in apartment buildings. It is important that the light be located on the residence such that it is easily seen from the road, walkway or other thoroughfare. Luminescent addresses, such as shown in U.S. Pat. No. 6,568,109, are contemplated for use in combination with the switch of the instant invention. It is understood that these are mere examples and the invention is not to be limited to these applications, but is broadly applicable whenever and wherever a response from emergency personnel is contemplated in the future. The essential features of the light source are 1) that the light source be intense enough to be quickly seen by a passing vehicle or individual on foot from the street, 2) that the light source be placed in direct line of sight of the street, and 3) that the light source is visible even in bright daylight. Where the device of the instant invention incorporates these three essential features, emergency response personnel can expeditiously and accurately locate the proper residence or place of business where the emergency originated at any time of day or night.

The switch can be made several different ways, so long as there is some particular way the switch is purposely engaged into the flash mode, as to avoid accidental engagement of the device. Means to engage the flash circuit could be mechanical or electrical. Such strobing mechanisms are found in U.S. Pat. No. 6,133,839 incorporated herein by reference.

A conventional 110-volt alternating current, as normally found in residential and commercial facilities, is utilized with the activation switch of the present invention. When the switch is engaged in the emergency response position, the 110-volt alternating current is directed in a strobing fashion to the light source. Any light that is conveniently located within sight of the street is appropriately connected electrically to the switch, whereby emergency response personnel can readily identify the proper location of the emergency. Important considerations are that the light is easily visible from the street, and that the light is intense enough to be visible even in broad daylight.

It is also contemplated that the emergency activator switch of the invention could be utilized to activate a light source within sight of the neighbors. In this mode, neighbors can be alerted to an emergency situation whereby they can call police or fire or emergency rescue personnel. Additionally, the emergency activator switch has utility in spousal abuse situations, all too common in today's society. Just the knowledge that a simple flip of the emergency activator switch will alert neighbors in a spousal abuse emergency has utility. In this mode of the invention, not only does the invention function to locate the site of the emergency for appropriate response personnel, but also acts as a deterrent to the abusing spouse.

### BRIEF DESCRIPTION OF THE SEVERAL VIEWS OF THE DRAWINGS

FIG. 1 shows a conventional toggle light switch, modified whereby the switch directs a standard 110-volt alternating house current through a mechanical (bi-metallic) or electronic circuit that modulates the house current in a strobing fashion. Any frequency that will direct a person's attention is appropriately utilized within the scope of the invention.

FIG. 2 is a profile perspective of the switch shown in FIG. 1.

FIG. 3 shows the internal switch circuit in schematic. The mechanism that modulates the standard 110-volt alternating house current can be mechanical, such as a bi-metallic strip means, or electronic such as a capacitor.

FIG. 4 shows the conventional toggle light switch, modified as in FIG. 1, fitted into a standard single-gang electrical box.

FIG. 5 shows two switches, either or both of which are modified according to the invention, fitted into a standard double-gang, electrical box.

FIG. 6 shows another embodiment of the present invention whereby a light located in the center of the toggle switch is activated to indicate that the outside light has been set into strobing action.

FIG. 7 shows another embodiment of the invention wherein a light indicates that the flash mode is activated.

FIG. 8 shows an embodiment of the electrical emergency locator switch whereby a three position toggle switch can be manipulated between three modes: on, off, and flash.

FIG. 9 is yet another species of the instant invention where the strobing outside light is activated by an infrared sensor, which is particularly desirable with handicapped individuals. A conventional toggle switch with three positions is additionally provided.

FIG. 10 shows an infrared remote control to be used in conjunction with the embodiment of the instant invention shown in FIG. 9 whereby a three position push button switch on a remote control is described.

### DETAILED DESCRIPTION OF THE INVENTION

The detailed disclosure of the invention is given through the description of the drawings.

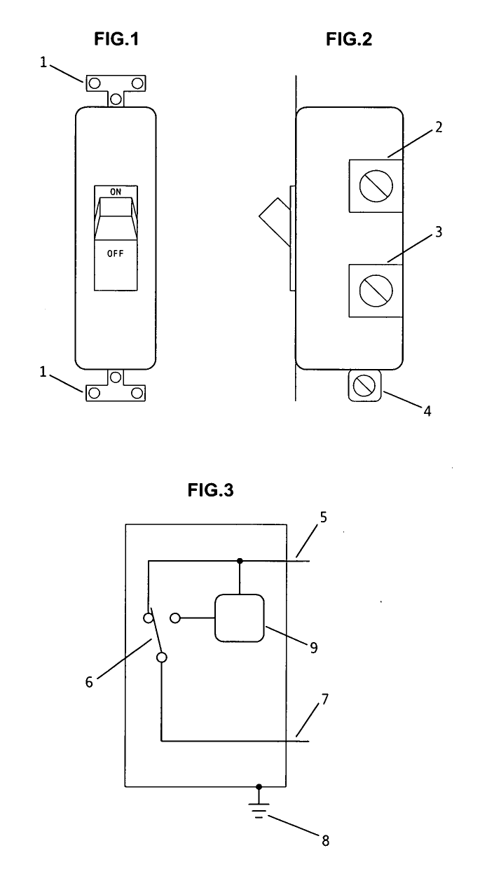

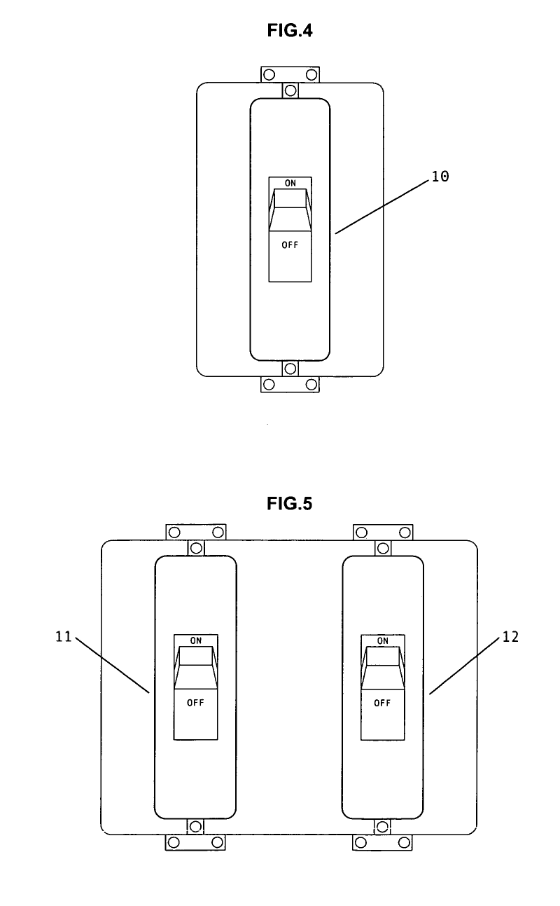

FIGS. 1 through 3 show the invention in its simplest embodiment. FIG. 1 is a conventional toggle 110-volt alternating current electrical switch, designed to fit into a conventional single gang box by screwing feet 1 into a single gang electrical box as shown in FIG. 4. Essential to the operation of the invention is the combination of the electrical switch shown in FIG. 1 with the internal flash circuit shown in FIG. 3. Many such circuits are described in the prior art. When the switch is engaged in the position shown in FIG. 1, current must pass through the circuit shown in FIG. 3, which is interposed in the electrical circuit between the switch of FIG. 1 and the electrical light chosen for strobing action. Current from terminal 3, as seen in FIG. 2, passes through the switch designated as 6 in FIG. 3, the flash circuit 9, as seen in FIG. 3, and ultimately to the light through terminal 2 as seen in FIG. 2 or 5 as seen in FIG. 3. Element 4 in FIG. 2 and element 8 in FIG. 3 represent ground connections.

In its most convenient form, the flash circuit 9 is internal to the switch. Both the switch and flash circuit fit within a conventional electrical box, and can be installed wherever a switch operates an outside light, provided the outside light possesses sufficient visibility to the street. However, it is expressly understood that the flash circuit could be separate from the switch. In that manner, the flash circuit could be installed between the electrical switch and the outside light in any existing home or business without changing either the switch or light.

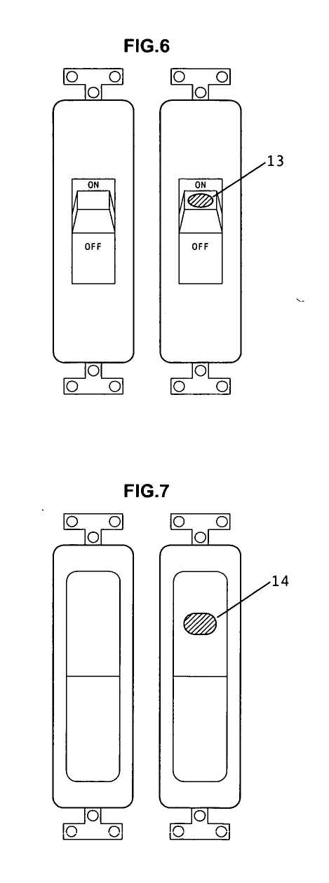

FIGS. 6 and 7 depict another embodiment of the invention. In this embodiment, the switch is provided with a light designated as element 13. Element 13 indicates when the strobing circuit and outside light are engaged. Such conventional lighted switches are conventional in the art, often used to illuminate a switch to find the electrical switch in a dark room. In this mode, however, the lighted switch operates when the switch is in strobe mode, not when the switch is off, in contrast to the commercially available switch that is illuminated when the switch is off.

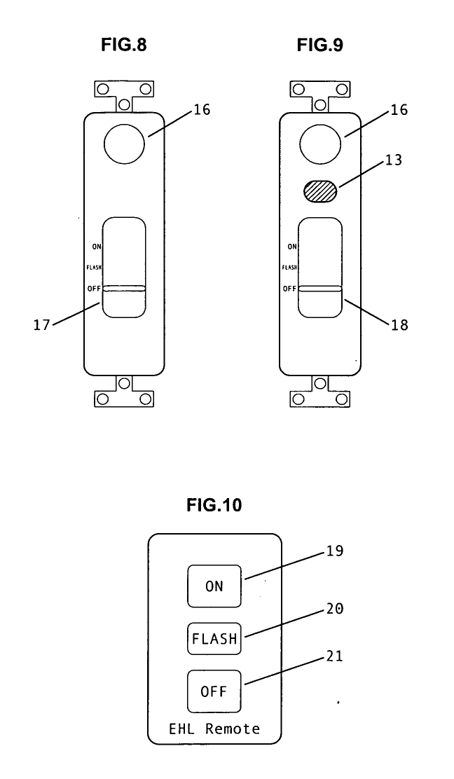

FIG. 8 shows yet another embodiment of the emergency help locator switch.

In this embodiment, toggle switch 17 can be manipulated between three positions: on off, and flash. In this embodiment, the outside light can be used for normal lighting as well as emergency location. Of course, the same flash circuits used in the other embodiments can be combined with the toggle switch of FIG. 8.

FIGS. 8 and 9 depict another embodiment of the instant invention utilizing an infrared sensor, here shown as element 16. Said sensor is provided in addition to the toggle switch. This additional infrared sensor is provided in anticipation of use of the device for handicapped or elderly individuals that cannot readily move to the switch. Infrared sensors usable in this embodiment are conventional in the art, and their exact design is not critical to practice of the emergency electrical strobing switch so long as the infrared sensor functions to engage the flash circuit interposed electrically between the line voltage and the outside light. Toggle switches 17 and 18 are also provided to enable the emergency help locator switch to be engaged in flash position without use of the infrared sensor, should the infrared sensor be unavailable or inoperable. FIG. 9 further includes the light element designated as 13 so as the light operator will know when the switch is in the flash position.

FIG. 10 is a mock up of the infrared remote control for use with the embodiments shown in FIGS. 8 and 9. As shown in FIG. 10, a conventional push-button switch on a remote control with three positions is used. The remote switch has three bias positions: on, as indicated in 19; off, as in 21; and flash, as in 20. Again, as in the other embodiments, the flash mode 20 passes the house current through the same flash circuits as used in other embodiments.

While specific objects and features of the subject invention have been disclosed in full detail herein, it will be readily understood that the invention encompasses all modifications and enhancements within the scope and spirit of the following claims.

What is claimed is:

1. An emergency locator device intended to alert emergency response personnel to the location of an emergency, comprising a light switch with on/off settings and further including a third setting which electrically connects light means in a strobing fashion to alert emergency response personnel to the location of the emergency, means to alternate current to the light means in a strobing fashion, light means which emits a high-intensity flashing light, and a power source connected to the emergency locator device.

2. The Emergency locator device of claim 1 where the power source is a conventional 110-volt house current.

3. The emergency locator device of claim 2 further including an emergency power source to operate the strobing light means in the event the conventional house alternating power source is unavailable.

4. The emergency locator device of claim 3 wherein the emergency power source is a battery means.

5. The emergency locator device of claim 4 wherein the battery means is a solar-rechargeable battery means.

6. The emergency locator device of claim 5 wherein the battery means is a battery means rechargeable using conventional AC current.

7. The emergency locator device of claim 1 further including means to prevent accidental strobing of the emergency locator device.

8. The emergency locator device of claim 7 wherein the means to prevent accidental strobing is an intermediate switch for strobing that must be engaged twice or more before strobing is engaged.

9. The emergency locator device of claim 7 wherein the means to prevent accidental strobing is a second switch that must be pressed for a predetermined length of time before the intermediate strobing setting of the emergency locator device is engaged.

10. The emergency locator device of claim 7 wherein the means to prevent accidental strobing of the emergency locator device is mechanical or electrical.

11. The emergency locator device of claim 7 wherein a timer automatically cuts off the strobing light means at a predetermined time in order to deactivate the emergency locator device in the event that the emergency locator switch is accidentally engaged.
